(19) United States
(12) Patent Application Publication
(10) Pub. No.: US 2017/0017912 A1
(43) Pub. Date: Jan. 19, 2017

(54) WORK ASSISTANCE DEVICE, WORK ASSISTANCE METHOD, AND NON-TRANSITORY COMPUTER-READABLE MEDIUM

(71) Applicant: FUJI XEROX CO., LTD., Tokyo (JP)

(72) Inventor: Kiyoshi TERAGUCHI, Yokohama-shi (JP)

(73) Assignee: FUJI XEROX CO., LTD., Tokyo (JP)

(21) Appl. No.: 15/019,214

(22) Filed: Feb. 9, 2016

(30) Foreign Application Priority Data
Jul. 13, 2015 (JP) 2015-139501

(51) Int. Cl. G06Q 10/06

(52) U.S. Cl. CPC G06Q 10/06313; G06Q 10/0635

(57) ABSTRACT

A work assistance device includes a workflow definition unit, a performance item setting unit, a proceeding unit, and a presentation unit. The workflow definition unit defines a workflow made up of multiple standard tasks and including multiple steps. If a non-standard task not constituting the workflow but relevant to the completion of the workflow and different from the standard tasks is produced, the performance item setting unit sets the non-standard task as a performance item to be performed in the workflow. The proceeding unit provisionally accepts that the performance item has been performed and proceeds with the step of the workflow. The presentation unit presents a due date of the performance item for the completion of the workflow by a deadline.

### CROSS-REFERENCE TO RELATED APPLICATIONS

This application is based on and claims priority under 35 USC 119 from Japanese Patent Application No. 2015-139501 filed Jul. 13, 2015.

### BACKGROUND

### Technical Field

The present invention relates to a work assistance device, a work assistance method, and a non-transitory computer-readable medium.

### SUMMARY

According to an aspect of the invention, there is provided a work assistance device including a workflow definition unit, a performance item setting unit, a proceeding unit, and a presentation unit. The workflow definition unit defines a workflow made up of multiple standard tasks and including multiple steps. If a non-standard task not constituting the workflow but relevant to the completion of the workflow and different from the standard tasks is produced, the performance item setting unit sets the non-standard task as a performance item to be performed in the workflow. The proceeding unit provisionally accepts that the performance item has been performed and proceeds with the step of the workflow. The presentation unit presents a due date of the performance item for the completion of the workflow by a deadline.

### BRIEF DESCRIPTION OF THE DRAWINGS

An exemplary embodiment of the present invention will be described in detail based on the following figures, wherein:

FIG. 1 is a schematic module configuration diagram for an exemplary configuration according to an exemplary embodiment;

FIG. 2 is an explanatory diagram illustrating an exemplary system configuration utilizing an exemplary embodiment;

FIG. 3 is a flowchart illustrating an exemplary process according to an exemplary embodiment;

FIG. 4 is a flowchart illustrating an exemplary process according to an exemplary embodiment;

FIG. 5 is a flowchart illustrating an exemplary process according to an exemplary embodiment;

FIG. 6 is an explanatory diagram illustrating an example of a workflow to be processed by an exemplary embodiment;

FIG. 7 is an explanatory diagram illustrating an exemplary data structure of a case log table;

FIG. 8 is an explanatory diagram illustrating a presentation example of a to-do creation screen;

FIG. 9 is an explanatory diagram illustrating a presentation example of a case information screen; and

FIG. 10 is a block diagram illustrating an exemplary hardware configuration of a computer that realizes an exemplary embodiment.

### DETAILED DESCRIPTION

Hereinafter, an exemplary embodiment related to realizing the present invention will be described by way of example on the basis of the drawings.

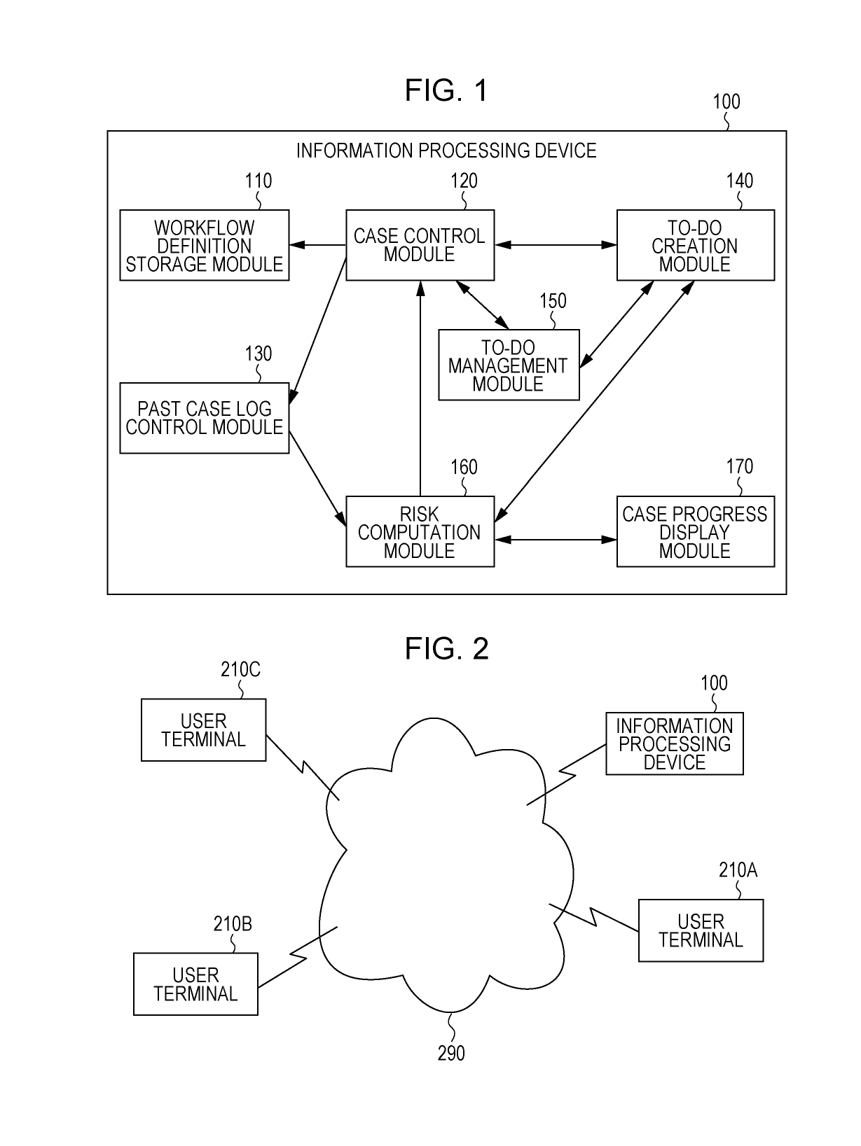

FIG. 1 illustrates a schematic module configuration for an exemplary configuration according to the exemplary embodiment.

Note that the term module refers to components such as software (computer programs) and hardware which are typically capable of being logically separated. Consequently, the term module in the exemplary embodiment not only refers to modules in a computer program, but also to modules in a hardware configuration. Thus, the exemplary embodiment also serves as a description of a computer program (a program that causes a computer to execute respective operations, a program that causes a computer to function as respective units, or a program that causes a computer to realize respective functions), a system, and a method for inducing functionality as such modules. Note that although terms like “store” and “record” and their equivalents may be used in the description for the sake of convenience, these terms mean that a storage device is made to store information or that control is applied to cause a storage device to store information in the case where the exemplary embodiment is a computer program. Also, while modules may be made to correspond with function on a one-to-one basis, some implementations may be configured such that one program constitutes one module, such that one program constitutes multiple modules, or conversely, such that multiple programs constitute one module. Moreover, multiple modules may be executed by one computer, but one module may also be executed by multiple computers in a distributed or parallel computing environment. Note that a single module may also contain other modules. Also, the term “connection” may be used hereinafter to denote logical connections (such as the transfer of data and referential relationships between instructions and data) in addition to physical connections. The term “predetermined” refers to something being determined prior to the processing in question, and obviously denotes something that is determined before a process according to the exemplary embodiment starts, but may also denote something that is determined after a process according to the exemplary embodiment has started but before the processing in question, according to conditions or states at that time, or according to conditions or states up to that time. In the case of multiple “predetermined values”, the predetermined values may be respectively different values, or two or more values (this obviously also includes the case of all values) which are the same. Additionally, statements to the effect of “B is conducted in the case of A” are used to denote that a determination is made regarding whether or not A holds true, and B is conducted in the case where it is determined that A holds true. However, this excludes cases where the determination of whether or not A holds true may be omitted.

Also, the terms “system” and “device” not only encompass configurations in which multiple computers, hardware, or devices are connected by a communication medium such as a network (including connections that support 1-to-1 communication), but also encompass configurations realized by a single computer, hardware, or device. The terms “device” and “system” are used interchangeably. Obviously, the term “system” does not include merely artificially arranged social constructs (social systems).

Also, every time a process is conducted by each module or every time multiple processes are conducted within a module, information to be processed is retrieved from a storage device, and the processing results are written back to the storage device after the processing. Consequently, description of the retrieval from a storage device before processing and the writing back to a storage device after processing may be reduced or omitted in some cases. Note that the storage device herein may include a hard disk, random access memory (RAM), an auxiliary or external storage medium, a storage device accessed via a communication link, and a register or the like inside a central processing unit (CPU).

An information processing device 100 according to the present exemplary embodiment is a work assistance device that assists in the performance of work in a workflow. As illustrated by the example of FIG. 1, the information processing device 100 includes a workflow definition storage module 110, a case control module 120, a past case log control module 130, a to-do creation module 140, a to-do management module 150, a risk computation module 160, and a case progress display module 170.

Note that work refers to one task involving input and output.

A workflow definition is a data set linking work items from a start work item to an end work item with transition conditions between work items.

A proposal is a flow started as one item of execution data from a workflow definition.

A case refers to the data proposed from a workflow definition.

The workflow definition storage module 110 is connected to the case control module 120. The workflow definition storage module 110 stores information defining a workflow made up of multiple standard tasks (hereinafter also called a workflow definition). A workflow definition in the workflow definition storage module 110 is acquired by the case control module 120.

The past case log control module 130 is connected to the case control module 120 and the risk computation module 160. The past case log control module 130 stores case data that was performed in the past (data related to a workflow controlled by the case control module 120 (for example, data indicating the start date, end date, and status of the work, and the worker)). Data for past cases may be acquired by specifying information such as the flow definition or work item.

The to-do creation module 140 is connected to the case control module 120, the to-do management module 150, and the risk computation module 160. When a non-standard task different from the standard tasks (the standard tasks constituting the workflow) is produced, in which the non-standard task does not constitute part of the workflow managed by the workflow definition storage module 110 but is relevant to the completion of the workflow, the to-do creation module 140 sets the non-standard task as an item to be performed as part of that workflow (hereinafter also referred to as a to-do item). Herein, a “non-standard work task” refers to a task that does not constitute part of the original workflow but is relevant to the completion of the workflow, and is different from the standard tasks. In particular, a non-standard task may be a task produced partway through the advancement of the workflow, and may include “tasks derived from standard tasks during the process of the workflow”.

Additionally, the to-do creation module 140 instructs the case control module 120 to provisionally accept that the performance item has been performed to proceed with that step of the workflow.

In addition, the to-do creation module 140 presents a due date for a performance item that is relevant to the completion of the workflow by a deadline. For example, the value of the difference between the due date of the workflow and a statistical value of past performance periods for that workflow is presented as a candidate for the due date of the performance item. Herein, a statistical value is a value such as the mean, mode, median, minimum, or maximum value of past performance periods. Specifically, a risk originating from the work that creates the performance item is acquired from the risk computation module 160, set as the due date when creating the performance item, and registered in the to-do management module 150.

The case control module 120 is connected to the workflow definition storage module 110, the past case log control module 130, the to-do creation module 140, the to-do management module 150, and the risk computation module 160. The case control module 120 acquires a workflow definition inside the workflow definition storage module 110, and makes a proposal. Herein, the actual process of “making a proposal” includes selecting a target workflow and starting that workflow.

Additionally, the case control module 120 controls work transitions within a workflow. Note that work whose status is changed to “provisionally accepted” by work status management may be transitioned to ongoing work as a provisional work result.

In particular, when a performance item discussed later is set, the case control module 120, following instructions from the to-do creation module 140, provisionally accepts that the performance item has been performed, and proceeds with that step of the workflow. Note that work produced by the performance item may also be provisionally accepted as performed to proceed with that step of the workflow.

In addition, the case control module 120 cooperates with the to-do management module 150, and when a provisional result of provisionally accepted work matches the result of the performance item related to (associated with) the work by the to-do management module 150, the case control module 120 finalizes the status of the provisionally accepted work to “performed”. Additionally, if the provisional result of the provisionally accepted work does not match the result of the performance item, the status of the provisionally accepted work is set to “remanded”, and the work is made to be performed again.

The to-do management module 150 is connected to the case control module 120 and the to-do creation module 140. The to-do management module 150 conducts status management of performance items.

The risk computation module 160 is connected to the case control module 120, the past case log control module 130, the to-do creation module 140, and the case progress display module 170. The risk computation module 160 acquires, from the past case log control module 130, past case data for each transition pattern from the provisionally accepted work result, and computes the risk of each transition pattern.

Herein, “risk” refers to an inexpedience caused by work not being completed by the deadline. For example, a risk may be a number of days late past the deadline, or a value such as losses incurred because of a delay past the deadline. For example, in the case of losses, the losses incurred in the event of the workflow not being performed by the deadline may be computed in advanced and presented.

The case progress display module 170 is connected to the risk computation module 160. The case progress display module 170 presents the progress of a workflow. The case progress display module 170 presents the risk of the workflow not being completed by the deadline because of a performance item not being performed. Herein, “a performance item not being performed” includes cases in which the performance item is not performed according to the original schedule, and more specifically, includes cases such as when the deadline for the performance item is exceeded, or when the performance item is performed as a formality but the content does not conform to expectations. “Because of a performance item not being performed” also includes times when the performance item is provisionally accepted and proceeded with. In other words, the setting of a performance item means that, since a non-standard task with a status of “not performed” is produced when setting the performance item, that performance item is not performed if provisionally accepted and proceeded with or left in a provisionally accepted state. Consequently, the “risk of the workflow not being completed by the deadline because of a performance item not being performed” includes the “risk of the workflow not being completed by the deadline because of proceeding by provisional acceptance”.

For example, the case progress display module 170 presents the progress status of a specified workflow, together with the due date of the workflow itself and a risk value computed by the risk computation module 160.

FIG. 2 is an explanatory diagram illustrating an exemplary system configuration utilizing an exemplary embodiment.

The information processing device 100, a user terminal 210A, a user terminal 210B, and a user terminal 210C are interconnected through a communication link 290. The communication link 290 may be wireless, wired, or a combination of the two, and may use a network such as the Internet or an intranet as a communication infrastructure, for example. Also, the functions provided by the information processing device 100 may also be realized as a cloud service.

A workflow is proposed by the information processing device 100 in response to a user operation on a user terminal 210. Subsequently, the workflow is followed and work is conducted by users assigned with respective work in the workflow, and information such as work content and work results are transmitted from the user terminals 210 to the information processing device 100. If a non-standard task not defined in the workflow is produced, a to-do item is created, the to-do item is provisionally accepted as performed, and that step of the workflow is proceeded with.

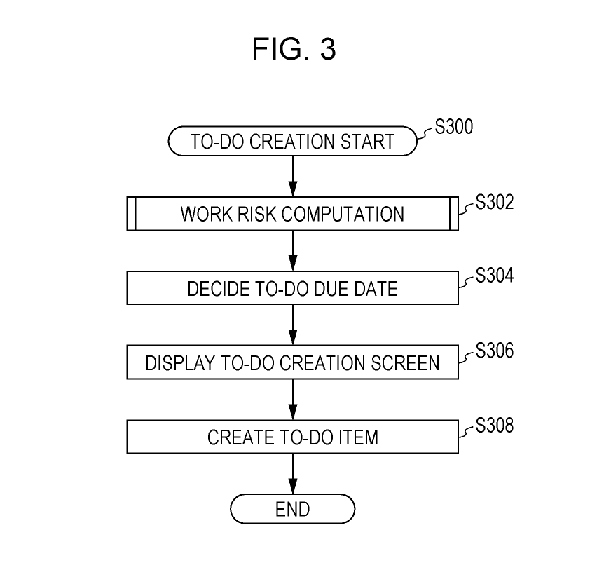

FIG. 3 is a flowchart illustrating an example process executed by the present exemplary embodiment (in particular, the to-do creation module 140 and the risk computation module 160).

In step S300, the creation of a to-do item is started. As discussed earlier, a to-do item is created when a non-standard task not defined in the workflow is produced.

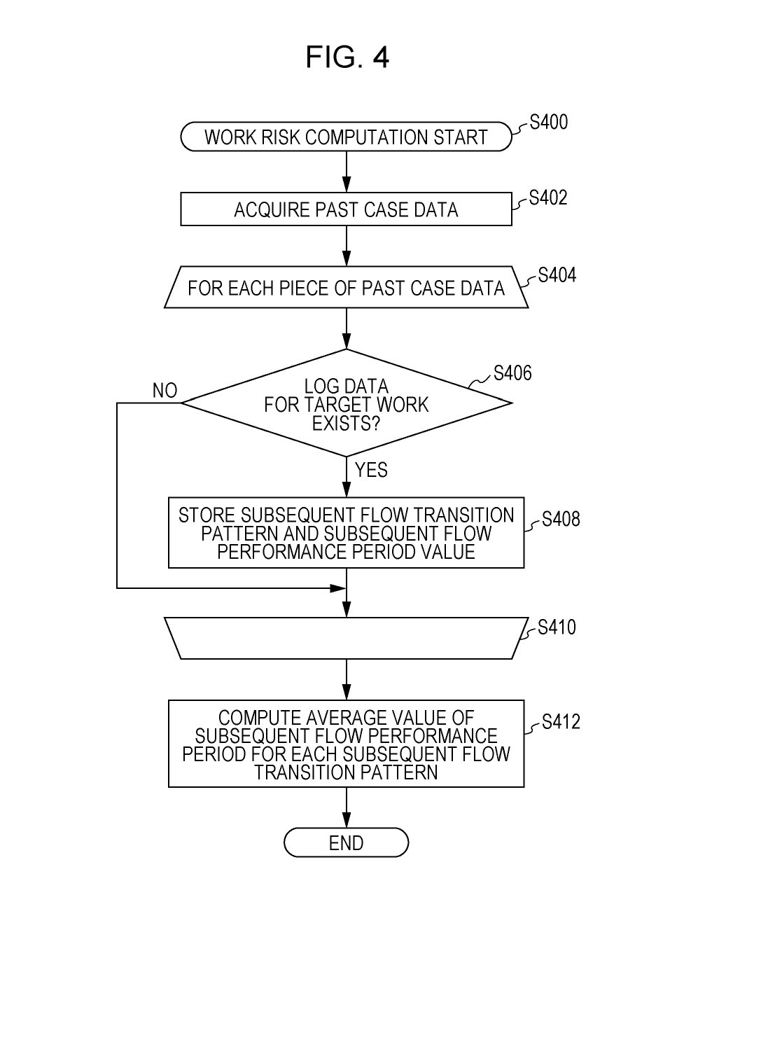

In step S302, the work risk is computed. The process of step S302 will be discussed later using the flowchart illustrated by the example of FIG. 4. Specifically, a workflow definition name and the work are used to acquire the risk from the risk computation module 160.

In step S304, the due date of the to-do item is decided. Specifically, a risk value matching the transition pattern that matches the provisional result of the provisionally accepted work and matching a risk pattern is decided as the due date of the to-do item.

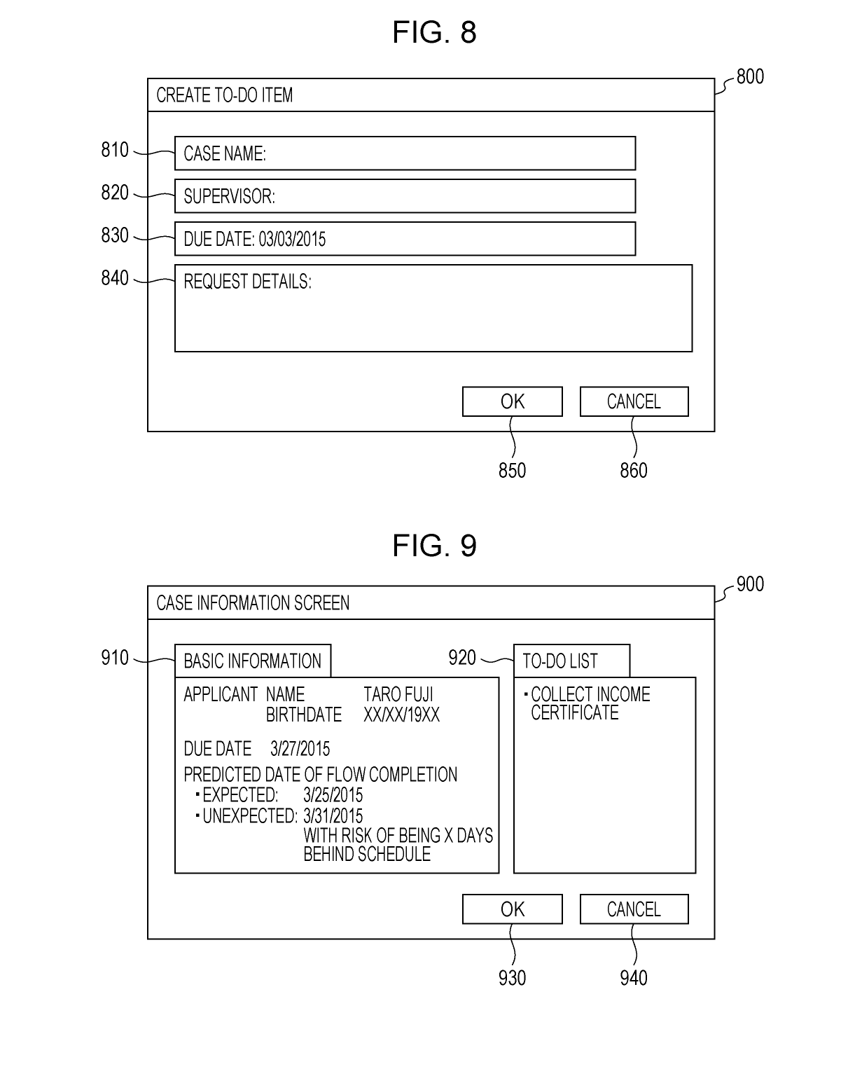

In step S306, the due date value decided in step S304 is displayed, and a to-do creation screen is displayed. For example, a to-do creation screen 800 is displayed on a liquid crystal display or other display device of a user terminal 210. FIG. 8 is an explanatory diagram illustrating a display example of the to-do creation screen 800. Displayed on the to-do creation screen 800 are a case name input field 810, a supervisor input field 820, a due date input field 830, a request details input field 840, an OK button 850, and a cancel button 860. Information is input into the case name input field 810, the supervisor input field 820, the due date input field 830, and the request details input field 840 by a user. The name of the to-do item is input into the case name input field 810. The name of the user to perform the to-do item is input into the supervisor input field 820. The due date of the to-do item is input into the due date input field 830. However, the due date of a to-do item relevant to the completion of the workflow by the deadline may also be displayed and correctable by a user. Process details about the to-do item are input into the request details input field 840. If the OK button 850 is selected, the to-do management module 150 is made to store the information input into the case name input field 810, the supervisor input field 820, the due date input field 830, and the request details input field 840. If the cancel button 860 is selected, the content input into the case name input field 810 and other fields is deleted.

In step S308, a to-do item is created. Specifically, a to-do item including the content of each field on the to-do creation screen 800 displayed in step S306 is registered in the to-do management module 150.

FIG. 4 is a flowchart illustrating an example process executed by the present exemplary embodiment (in particular, the risk computation module 160).

In step S400, the computation of work risk is started.

In step S402, past case data is acquired from the past case log control module 130. Specifically, past case data matching the target workflow definition name is acquired from the past case log control module 130.

In step S404, the process up to step S410 is repeated for the number of acquired pieces of past case data.

In step S406, it is determined whether or not log data for the target work exists, and if so, the process proceeds to step S408, otherwise the process proceeds to step S410. Specifically, for each past case log entry acquired in step S402, if work matching the target work exists as executed work in the past case log control module 130 (step S406, Yes), information associating the subsequent flow transition pattern and subsequent flow performance period value is stored (step S408).

In addition, if multiple routes exist inside one workflow (if branching exists), it is determined whether or not the target work is included. Furthermore, a condition of matching the content of the to-do item may also be set. Also, if the content of the to-do item is confirmed to be the same, the determination of whether or not the content of the to-do item matches may also be skipped.

In step S408, the subsequent flow transition pattern and the subsequent flow performance period value are stored.

In step S412, the average value of the subsequent flow performance period for each subsequent flow transition pattern is computed. Additionally, the value of the difference between the due date of the target workflow and the average value is taken to be the risk value.

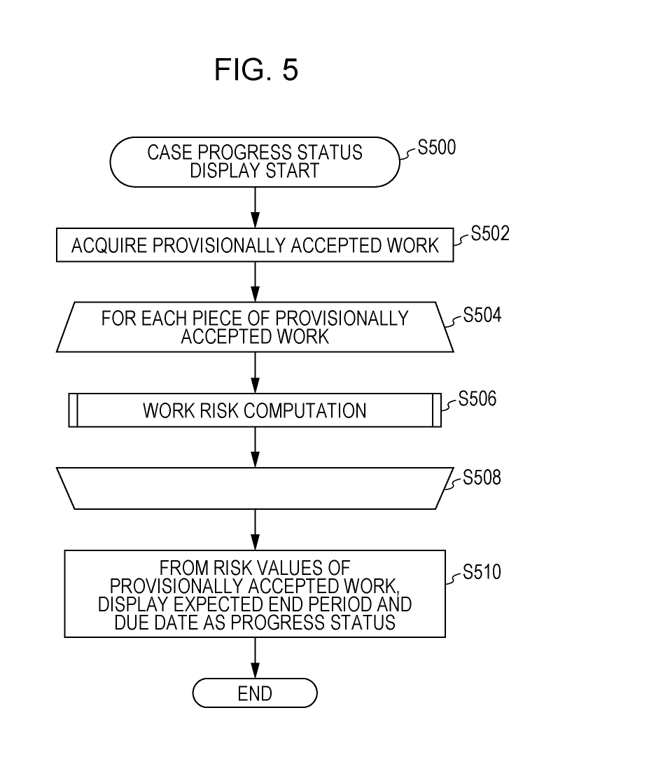

FIG. 5 is a flowchart illustrating an example process executed by the present exemplary embodiment (in particular, the case progress display module 170).

In step S500, the case progress status display is started.

In step S502, work that was provisionally accepted and proceeded with due to the creation of a to-do item is acquired. Specifically, all provisionally accepted work within the target workflow is acquired from the case control module 120.

In step S504, the process up to step S508 is repeated for the number of acquired pieces of provisionally accepted work.

In step S506, the risk of the provisionally accepted work is computed. A work risk value is computed for each piece of provisionally accepted work. The process of step S506 is the same as that discussed earlier using the flowchart illustrated by the example of FIG. 4.

In step S510, an expected end period and due date from the risk values of the provisionally accepted work are displayed as the progress status. Specifically, for each piece of provisionally accepted work, the value obtained by adding, to the current time, the period in the case of the provisional result being the same in the subsequent flow pattern, and the value obtained by adding, to the current time, the average value of the period for each subsequent flow pattern in the case of the provisional result being different, are displayed in comparison to the due date as the case progress status.

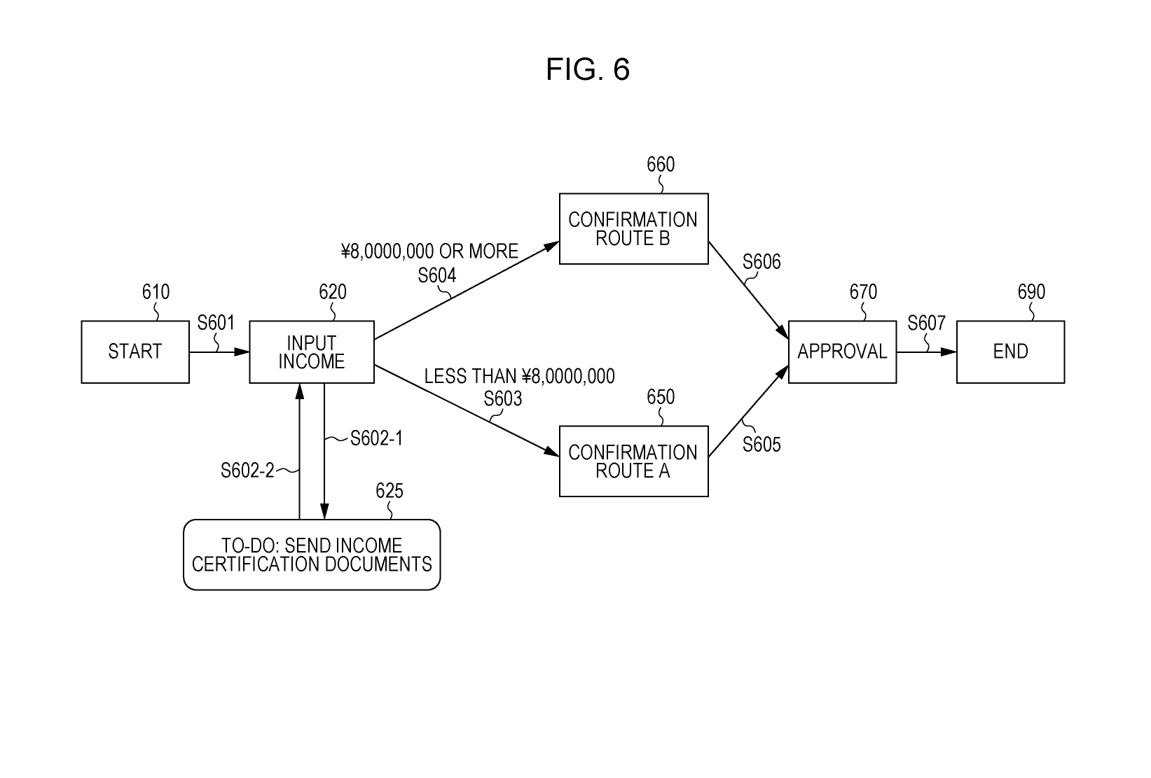

FIG. 6 is an explanatory diagram illustrating an example of a workflow to be processed by an exemplary embodiment. Suppose that a workflow made up of Start 610, Input Income 620, Confirmation Route A 650, Confirmation Route B 660, Approval 670, and End 690 defines an approval process for a loan application. “To-do: Send income certification documents” 625 is a to-do item created as a result of a non-standard task being produced by Input Income 620.

The workflow illustrated by the example of FIG. 6 is a simple workflow of a loan assessment application, in which the approval route changes according to whether the loan applicant's income is at least ¥8,000,000, or less than ¥8,000,000. Also, income certification documents may be required for confirming income, and if official income certification documents are not available during Input Income 620, it is possible to wait for the applicant to send documents as a to-do item, treat the self-reported income value on the application from the applicant as a provisional value, and advance the flow up to just before the “Approval 670” work.

In step S601, the flow goes from Start 610 to Input Income 620. In Input Income 620, “To-do: Send income certification documents” 625 is created.

In step S602-1, the flow goes from Input Income 620 to “To-do: Send income certification documents” 625.

In step S602-2, the flow goes from “To-do: Send income certification documents” 625 to Input Income 620.

In step S603, if the loan applicant's income is less than ¥8,000,000, the flow goes from Input Income 620 to Confirmation Route A 650.

In step S604, if the loan applicant's income is at least ¥8,000,000, the flow goes from Input Income 620 to Confirmation Route B 660.

In step S605, the flow goes from Confirmation Route A 650 to Approval 670.

In step S606, the flow goes from Confirmation Route B 660 to Approval 670.

In step S607, the flow goes from Approval 670 to End 690.

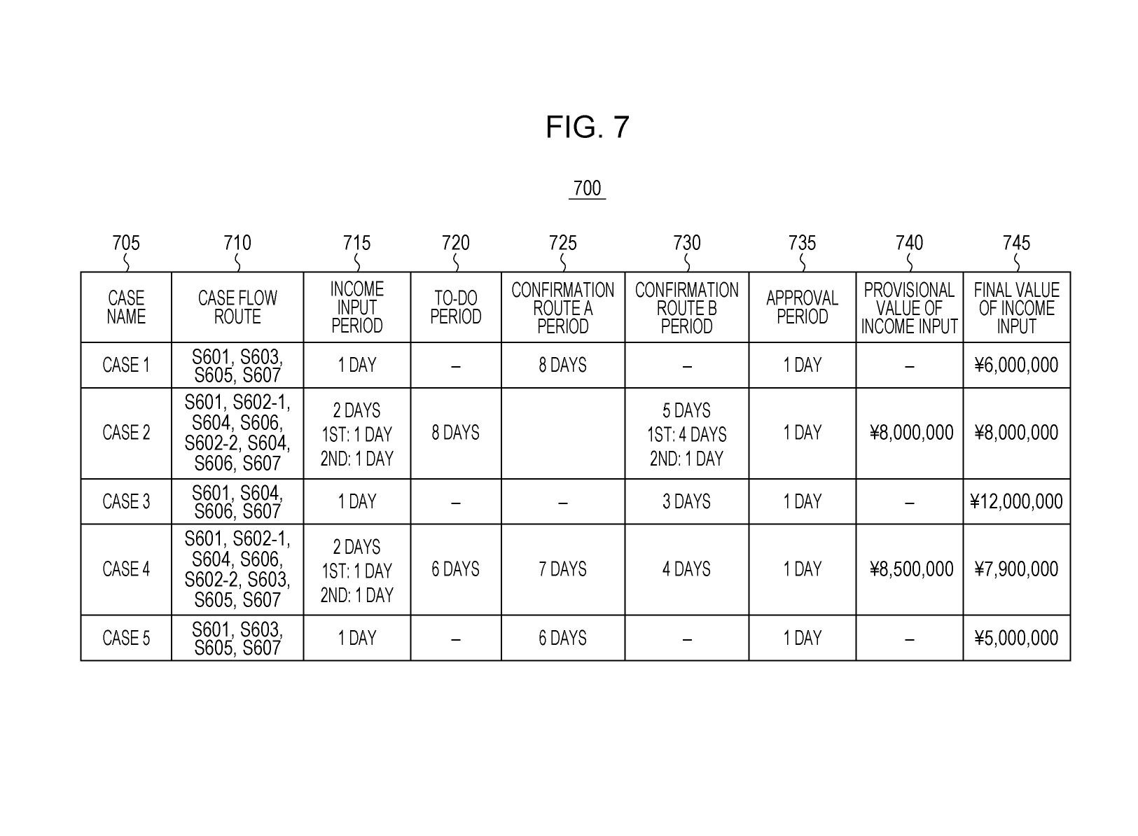

The case log table 700 is an example of a past log of the workflow illustrated by the example in FIG. 6. FIG. 7 is an explanatory diagram illustrating an example data structure of the case log table 700. The case log table 700 is stored in the past case log control module 130.

The case log table 700 includes a case name field 705, a case flow route field 710, an income input period field 715, a to-do period field 720, a confirmation route A period field 725, a confirmation route B period field 730, an approval period field 735, a provisional value of income input field 740, and a final value of income input field 745. The case name field 705 stores the name of the case that performed the workflow. The case flow route field 710 stores the flow route that was actually performed in the relevant case. The income input period field 715 stores the duration of the work for Input Income 620. The to-do period field 720 stores the duration of the work for “To-do: Send income certification documents” 625. The confirmation route A period field 725 stores the duration of the work for Confirmation Route A 650. The confirmation route B period field 730 stores the duration of the work for Confirmation Route B 660. The approval period field 735 stores the duration of the work for Approval 670. The provisional value of income input field 740 stores a provisional value of the income in Input Income 620 (a provisional value of the income if income certification documents were not attached). The final value of income input field 745 stores a final value of the income input in Input Income 620 (a final value of the income if income certification documents were attached).

Note that in Case 1, Case 3, and Case 5, income certification documents were attached, and provisional acceptance did not occur. In Case 2 and Case 4, income certification documents were not attached, “To-do: Send income certification documents” 625 was created, and provisional acceptance occurred. Additionally, if the provisional value of income input field 740 and the final value of income input field 745 have the same value, like in Case 2, the same route (Confirmation Route B 660) is followed two times. Meanwhile, if the provisional value of income input field 740 and the final value of income input field 745 have different values (such as when an income of at least ¥8,000,000 was provisionally input, but the income was less than ¥8,000,000 according to the income certification documents), like in Case 4, different routes (Confirmation Route B 660, Confirmation Route A 650) are followed.

From this state, an example of computing a to-do due date and an example of computing the risk value of the case progress will be illustrated for a newly created case (Case 6) in which the provisional value of the income is ¥12,000,000, the due date is in 14 days, and in addition, income certification documents are not attached, and thus “To-do: Send income certification documents” 625 is created.

(1) Precedents in the log of “Input Income 620” are extracted. Specifically, Cases 1 to 5 are extracted from the case log table 700 illustrated by the example of FIG. 7. Note that in the workflow illustrated by the example of FIG. 6, since “Input Income 620” is typically performed, the entire past case log (case log table 700) is applicable.

(2) The average performance period for each route of the subsequent flow is computed as follows. The average performance period is computed using the number of days taken by work performed after the first performance of Input Income 620, which is the work in which a to-do item is created. Specifically, when Input Income 620 is performed two times, the number of days taken by the second time, and the number of days taken by Confirmation Route A 650, Confirmation Route B 660, and Approval 670, are processed in the computation. The following four routes exist as possible transition patterns.

(2-1) “S601, S603, S605, S607” is treated as Route 1. The cases corresponding to Route 1 are “Case 1” and “Case 5”, and the average period is 8 days. Specifically, it is sufficient to sum the values in the confirmation route A period field 725 and the approval period field 735 for each case, and compute the average value.

(2-2) “S601, S602-1, S604, S606, S602-2, S604, S606, S607” is treated as Route 2. The case corresponding to Route 2 is “Case 2”, and the average period is 7 days. Specifically, it is sufficient to add together the second value of the income input period field 715 and the values of the confirmation route B period field 730 and the approval period field 735.

(2-3) “S601, S604, S606, S607” is treated as Route 3. The case corresponding to Route 3 is “Case 3”, and the average period is 4 days. Specifically, it is sufficient to add together the values of the confirmation route B period field 730 and the approval period field 735.

(2-4) “S601, S602-1, S604, S606, S602-2, S603, S605, S607” is treated as Route 4. The case corresponding to Route 4 is “Case 4”, and the average period is 13 days. Specifically, it is sufficient to add together the second value of the income input period field 715 and the values of the confirmation route A period field 725, the confirmation route B period field 730, and the approval period field 735.

(3) The average value of the average performance period for each route is 8 days. Since the due date for Case 6 currently being processed is in 14 days, 6 days from now (14−8=6) is presented as the due date of “To-do: Send income certification documents” 625. In other words, the maximum period over which “To-do: Send income certification documents” 625 may take to complete the workflow by the deadline is computed.

For example, as discussed earlier, a date 6 days from now is presented in the due date input field 830 of the to-do creation screen 800 illustrated by the example of FIG. 8. This due date may also be modified. However, if a date later than the due date is specified, a warning may be presented to indicate that the due date may not be met.

(4) In addition, the risk computation for the case progress presentation is respectively computed according to the following depending on whether the actual income is the same as or different from the provisional value.

(4-1) Case in which Actual Income is Same as Provisional Value

Since Route 2 and Route 3 are applicable, the average period for cases in which the actual income is the same as the provisional value is 5.5 days, and the sum of the 6 days until the to-do due date and 5.5 days is 11.5 days. Thus, the due date risk at the present time is presented as being no risk.

(4-2) Case in which Actual Income is Different from Provisional Value

Since Route 4 matches, the average period is 13 days, and the sum of the 6 days until the to-do due date and 13 days is 19 days. Thus, the case due date (in 14 days) is exceeded, and a risk of going past the due date by 5 days is presented.

A case information screen 900 illustrated by the example of FIG. 9 is presented. On the case information screen 900, a basic information display area 910, a to-do list display area 920, an OK button 930, and a cancel button 940 are presented. Within the basic information display area 910, information related to the proposed workflow (such as the name of the loan applicant), the due date, and the predicted date of flow completion are presented, for example. Additionally, the following two cases are presented as the predicted date of flow completion.

(1) The predicted completion date if the provisionally accepted result is as expected (in other words, income certification documents certifying the income input into Input Income 620 the first time are provided). Additionally, the risk computed in (4-1) discussed above (specifically, no risk (no delay)).

(2) The predicted completion date if the provisionally accepted result is unexpected (in other words, the to-do item is not performed as originally expected; specifically, income certification documents are provided which do not certify the income input into Input Income 620 the first time). Additionally, the risk computed in (4-2) discussed above (specifically, a risk of going past the due date by 5 days).

In the to-do list display area 920, the content of the created to-do item (“To-do: Send income certification documents” 625) is presented. If multiple to-do items are created in the proposed workflow, all to-do items are presented. Alternatively, to-do items which have not yet been performed may be presented.

If the OK button 930 or the cancel button 940 is selected, the case information screen 900 is removed from the screen.

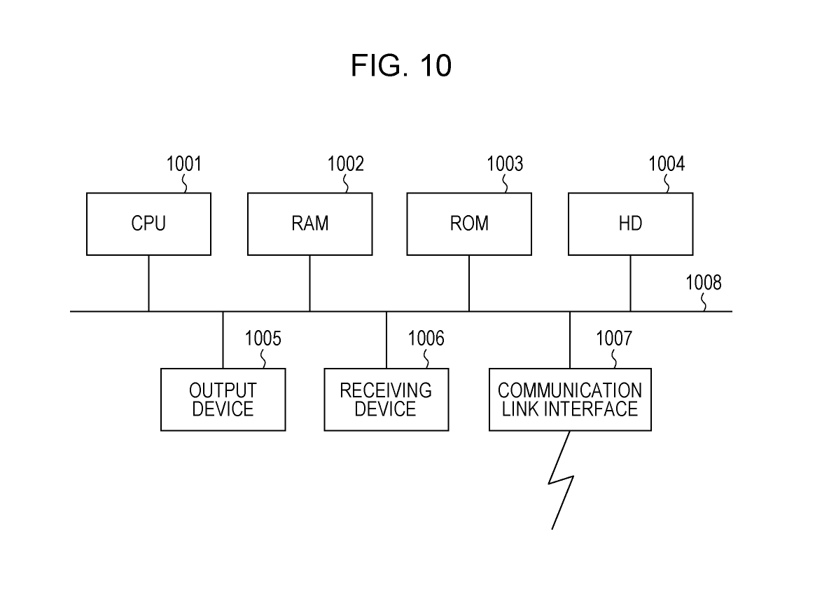

Note that a hardware configuration of a computer executing a program that acts as the present exemplary embodiment is a general computer as illustrated by the example of FIG. 10, and specifically is a computer or the like that may be a personal computer or a server. In other words, as a specific example, a CPU 1001 is used as a processing unit (computational unit), while RAM 1002, ROM 1003, and an HD 1004 are used as storage devices. For the HD 1004, a hard disk or a solid-state drive (SSD) may be used, for example. The computer is made up of the CPU 1001 that executes programs such as the case control module 120, the to-do creation module 140, the to-do management module 150, the risk computation module 160, and the case progress display module 170, the RAM 1002 that stores such programs and data, the ROM 1003 that stores programs and the like for activating the computer, the HD 1004 which is an auxiliary storage device (and may also be flash memory or the like) that may function as the past case log control module 130, a receiving device 1006 that receives data on the basis of operations performed by a user with device such as a keyboard, mouse, touch panel, or microphone, an output device 1005 such as a CRT, liquid crystal display, or a speaker, a communication link interface 1007 such as a network interface card for connecting to a communication network, and a bus 1008 for joining and exchanging data with the above components. Multiple such computers may also be connected to each other by a network.

Of the foregoing exemplary embodiments, for those made up of a computer program, software in the form of a computer program is made to be read into a system with the above hardware configuration, and the foregoing exemplary embodiments are realized by the cooperative action of the software and hardware resources.

Note that the hardware configuration illustrated in FIG. 10 illustrates a single exemplary configuration, and that the exemplary embodiment is not limited to the configuration illustrated in FIG. 10 insofar as the configuration still enables execution of the modules described in the exemplary embodiment. For example, some modules may also be realized with special-purpose hardware (such as an application-specific integrated circuit (ASIC), for example), and some modules may be configured to reside within an external system and be connected via a communication link. Furthermore, it may also be configured such that multiple instances of the system illustrated in FIG. 10 are connected to each other by a communication link and operate in conjunction with each other. Additionally, besides a personal computer in particular, an exemplary embodiment may also be incorporated into a device such as a mobile information/communication device (including devices such as a mobile phone, a smartphone, mobile equipment, and a wearable computer), information appliance, robot, photocopier, fax machine, scanner, printer, or multi-function device (that is, an image processing device having two or more from among scanning, printing, copying, and faxing functions).

Note that the described program may be provided stored in a recording medium, but the program may also be provided via a communication medium. In this case, a computer-readable recording medium storing a program, for example, may also be taken to be an exemplary embodiment of the present invention with respect to the described program.

A “computer-readable recording medium storing a program” refers to a computer-readable recording medium upon which a program is recorded, and which is used in order to install, execute, and distribute the program, for example.

The recording medium may be a Digital Versatile Disc (DVD), encompassing formats such as DVD-R, DVD-RW, and DVD-RAM defined by the DVD Forum and formats such as DVD+R and DVD+RW defined by DVD+RW Alliance, a compact disc (CD), encompassing formats such as read-only memory (CD-ROM), CD Recordable (CD-R), and CD Rewritable (CD-RW), a Blu-ray Disc (registered trademark), a magneto-optical (MO) disc, a flexible disk (FD), magnetic tape, a hard disk, read-only memory (ROM), electrically erasable and programmable read-only memory (EEPROM (registered trademark)), flash memory, random access memory (RAM), or a Secure Digital (SD) memory card, for example.

In addition, all or part of the above program may also be recorded to the recording medium and saved or distributed, for example. Also, all or part of the above program may be communicated by being transmitted using a transmission medium such as a wired or wireless communication network used in a local area network (LAN), a metropolitan area network (MAN), a wide area network (WAN), an internet, an intranet, an extranet, or some combination thereof, or alternatively, by being modulated onto a carrier wave and propagated.

Furthermore, the above program may be part of another program, and may also be recorded to a recording medium together with other separate programs. The above program may also be recorded in a split manner across multiple recording media. The above program may also be recorded in a compressed, encrypted, or any other recoverable form.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A work assistance device comprising:
a workflow definition unit that defines a workflow made up of a plurality of standard tasks, the workflow including a plurality of steps;
a performance item setting unit that, if a non-standard task not constituting the workflow but relevant to the completion of the workflow and different from the standard tasks is produced, sets the non-standard task as a performance item to be performed in the workflow;
a proceeding unit that provisionally accepts that the performance item has been performed and proceeds with the step of the workflow; and
a presentation unit that presents a due date of the performance item for the completion of the workflow by a deadline.

2. The work assistance device according to claim 1, further comprising:
a progress presentation unit that presents a progress of a workflow, wherein
the progress presentation unit presents a risk of the workflow not being completed by the deadline due to the performance item not being performed.

3. The work assistance device according to claim 1, wherein
the presentation unit presents a value of the difference between a due date of the workflow and a statistical value of past performance periods for the workflow as a candidate for the due date of the performance item.

4. The work assistance device according to claim 2, wherein
the presentation unit presents a value of the difference between a due date of the workflow and a statistical value of past performance periods for the workflow as a candidate for the due date of the performance item.

5. A work assistance method comprising:
defining a workflow made up of a plurality of standard tasks, the workflow including a plurality of steps;
setting a performance item, wherein if a non-standard task not constituting the workflow but relevant to the completion of the workflow and different from the standard tasks is produced, the non-standard task is set as a performance item to be performed in the workflow;
provisionally accepting that the performance item has been performed and proceeding with the step of the workflow; and
presenting a due date of the performance item for the completion of the workflow by a deadline.

6. A non-transitory computer-readable medium storing a program causing a computer to execute a process for assisting work, the process comprising:
defining a workflow made up of a plurality of standard tasks, the workflow including a plurality of steps;
setting a performance item, wherein if a non-standard task not constituting the workflow but relevant to the completion of the workflow and different from the standard tasks is produced, the non-standard task is set as a performance item to be performed in the workflow;
provisionally accepting that the performance item has been performed and proceeding with the step of the workflow; and
presenting a due date of the performance item for the completion of the workflow by a deadline.
